(19) United States
(12) Patent Application Publication
(10) Pub. No.: US 2008/0263235 A1
(43) Pub. Date: Oct. 23, 2008

(54) Device-to-Device Sharing of Digital Media Assets

(75) Inventors: Mathieu C. HANS, Hoffman Estates, IL (US); Jonathan R. Engelsma, Hudsonville, MI (US); Michael D. Pearce, Barrington, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/738,805

(22) Filed: Apr. 23, 2007

(51) Int. Cl. G06F 13/28

(52) U.S. Cl. 710/22

(57) ABSTRACT

Apparatus, a method, or an electronic device may be provided. Media and a data structure encoded on the media are each provided, to hold one or more digital media assets (DMAs). One or more share tools may be provided, which are configured to provide at least a target device of plural separate communication devices share access to a given DMA to which another source device of plural separate communication devices has access. The share access may be provided in response to a single share event at one of the source and target devices.

### BACKGROUND OF THE INVENTION

1. Field of the Invention

The present disclosure relates to the sharing of digital media assets between devices. The devices may, for example, be embedded devices, such as mobile phones.

2. Background

Various types of devices have share mechanisms, whereby one device is able to share a given digital media asset (DMA) (e.g., a picture or a game) with another device. Such devices include, for example, embedded devices (e.g., mobile phones), personal digital assistants, laptop computers, desktop computers, or any appliance or device with inter-communication capabilities. When a DMA is shared between source and target devices, the target device is provided with “share access” to a DMA to which the source device already has access. The DMA may be stored in a memory of the source device, and/or it may be stored elsewhere. The DMA, once shared, is accessible by the target device via a connection, for example, a network connection. The network connection may be wired or wireless.

### SUMMARY

In accordance with one aspect of the disclosure, apparatus are provided. The apparatus may include media, a data structure encoded on the media, and one or more share tools. The data structure may be encoded on the media to hold one or more digital media assets (DMAs). The one or more share tools may be configured to provide at least a target device of plural separate communication devices with share access to a given DMA, where another, source device, of the plural separate communication devices already has access to the given DMA. The share access may be provided in response to a single share event at one of the source and target devices.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram of a device with a data transfer capability;

FIG. 2 is a flowchart of a share orchestration process;

FIG. 3 is a flowchart of a share fulfillment process;

FIG. 4 is a schematic diagram of a device user interface, including one or more DMA share event tools;

FIG. 5 is a schematic diagram of a device user interface including other share tools;

FIG. 6 is a schematic diagram of an association mechanism;

FIG. 7 is a schematic diagram of an inference mechanism; and

FIG. 8 is a communication protocol diagram.

### DETAILED DESCRIPTION

Various features and advantages of example embodiments are set forth in the description which follows. While specific embodiments and implementations are discussed, it should be understood that these specifics are for illustration purposes only. It should be recognized that other components and configurations may be used without departing from the spirit and scope as set forth, for example, in the claims.

Embodiments described herein may include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code or other data, including data structures, in the form of computer-executable instructions or data representations, or data structures. When information is transferred or provided over a network or another communications collection (either hard wired, wireless, or a combination thereof) to a computer, the computer properly views the connection as a computer-readable medium. Thus, any such connection is properly termed a computer-readable medium. Combinations of the above should also be included within the scope of computer-readable media or medium.

Computer-executable instructions include, for example, instructions and data which cause a general purpose computer, a special purpose computer, or a special purpose processing device to perform a certain function or group of functions. Computer-executable instructions also include program modules or other portions that are executed by computers in standalone or network environments. Processing can be on one platform or distributed among plural platforms. Generally, program modules include routines, programs, objects, components, data structures, and so on, that perform tasks or implement abstract data types. Computer-executable instructions, data structures associated with such instructions, and program modules are examples of program code for executing steps or acts as disclosed herein. A particular sequence of executable instructions or associated data content, including data structures, represents examples of corresponding acts for implementing the functions described in such steps.

Referring now to the drawings in greater detail, in certain embodiments of the present disclosure, apparatus, a method, or an electronic device may be provided. The present disclosure may also be directed to one or more portions of such apparatus, method, or electronic device, or a plural set of more than one such apparatus, method, or electronic device.

In accordance with one embodiment, apparatus are provided including a display, a user interface, media, and one or more share tools. The user interface is associated with the display. The media includes a data structure encoded on the media to hold one or more digital media assets (DMAs). The one or more share tools is/are configured to provide one of two (or more) separate communications devices with share access to a given DMA, where another of the two separate communication devices already has access to the given DMA. The share access may be provided in response to a single share event at one of the two separate communication devices.

A “share event”, per embodiments herein, involves a user interaction with the device (i.e., a user interaction within one of the communication devices) causing or enabling a share (including a share orchestration and/or a share fulfillment, each defined below) to occur.

The DMA may include data causing the apparatus to have access to a given session of a game currently being played by a user on an embedded device separate from the apparatus. The DMA may be executable code of a game. The DMA may include a media file, for example, a photo, a video, or an audio file. The DMA may be data causing the apparatus to have access to a concurrent multi-party voice communication (e.g., a telephone call) involving one or more users of one or more devices separate from the apparatus. The DMA may also be a link, for example, a URL.

The single share event may include one click at a source device (of the two or more separate communication devices) already having access to the given DMA, to thereby provide the share access to one or more target devices being other one(s) of the two or more separate communication devices. The single share event may also (or alternatively) include one click at a target device of the two or more separate communication devices, the target device not yet having access to the given DMA, to thereby provide the share access to the target device from the source device.

Per one embodiment, share access to a given DMA (for a given target device) may occur automatically upon the occurrence of the single share event at a source device of the separate communication devices, or at the given target device of the separate communication devices. Per another embodiment, such share access (to a given target device) may occur only when both the source device's and the target device's share events occur within a predetermined amount of time of each other.

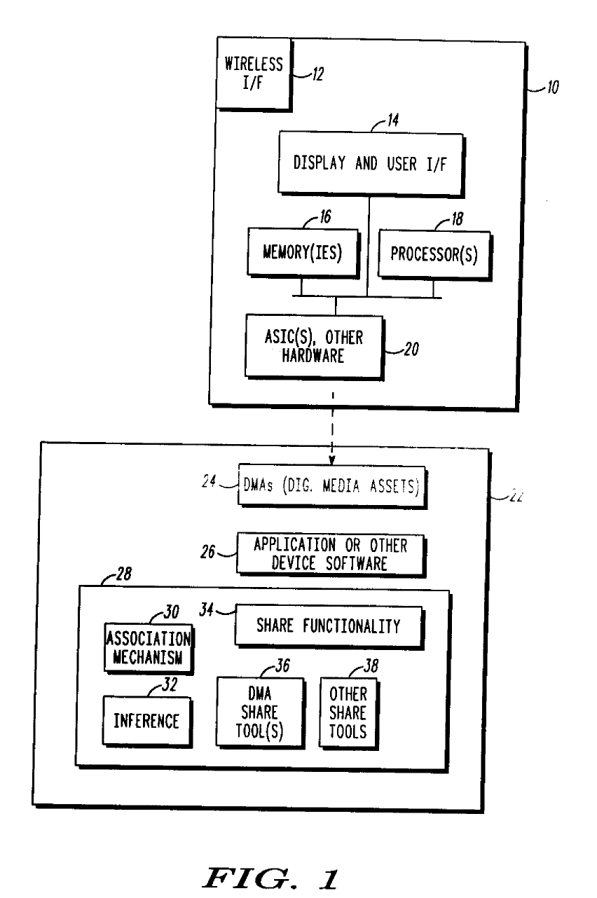

Referring now to the drawings in greater detail, FIG. 1 illustrates an example device 10 with a data transfer capability, including share features in accordance with one embodiment of the present disclosure. The illustrated device 10 includes (when it has wireless communication capabilities) a wireless interface 12. Device 10 further includes a display and associated user interface 14, one or more memories 16, one or more processors 18, and other hardware 20 which may include one or more application specific integrated circuits (ASICs).

The combination of elements in device 10 may be configured so that, when interacting with each other, they cause a permanent or temporal creation of one or more digital media asset (DMA) components 22. The illustrated DMA components 22 include one or more DMAs 24, an application or other device software 26, and share components 28. The illustrated share components 28 include an association mechanism 30, a target inference mechanism 32, share functionality 34, DMA share tool or tools 36, and other share tools 38.

The DMAs 24 may include, for example, a game, a photo, an audio message, a contact entry (for example, phone number), a multi-user game session, or a multi-user voice communication (for example, a telephone call). The application or other device software 26 may include, for example, a photo capture and/or view application or an audio capture and/or playback application. The application or other device software 26 may further include the device operating system, or a game interface for facilitating the execution, on the device, of one or more games which can be played by a user interacting with the device via display and user interface 14.

The share components 28 include share functionality 34. The share functionality 34 causes the sharing of DMAs between the current device and one or more other devices, for example, through a communications media, which may be wireless or wired, or a combination of both. A DMA may be shared with another device by pushing the DMA to the other device. A DMA may be shared from another device by pulling the DMA from the other device. A share between devices may involve a two-way data transfer (i.e., push and pull).

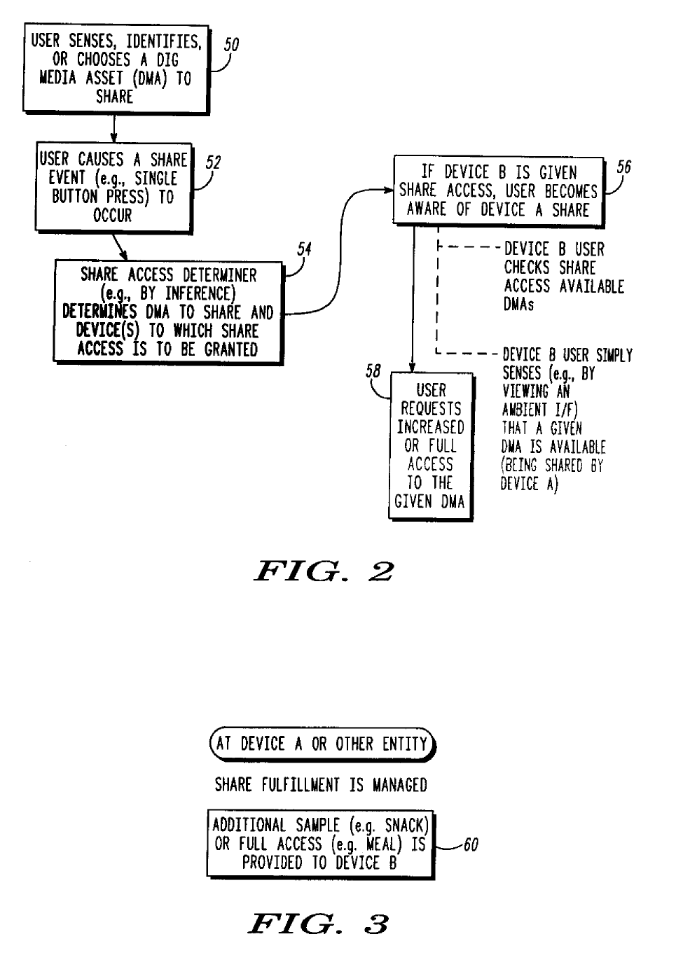

FIG. 2 shows a flow chart involving a share orchestration. Share orchestration involves a process by which a given DMA already provided to one device is shared with another device. Share orchestration may or may not involve actual fulfillment of the share, i.e., providing full access to the target device of the shared given DMA. Rather, share orchestration is primarily concerned with making the given DMA available to the target device. In the illustrated example, the source device is device A and the target device is device B.

At the source device (device A in the illustrated example), in act 50, a user senses, for example, hears, sees by the display, or feels (e.g., through vibration of the device), identifies, or chooses a DMA to share. In a next act 52, at the same device A, the user causes a share event (for example, by performing a single button press of a share button or a key on the device designated for providing share availability) to occur.

At a next act 54, a share access determiner (for example, at device A or at some other entity) determines (for example, by inference) the DMA to be shared and one or more target devices to which share access is to be granted.

In the illustrated example, one target device (device B) is provided share access.

At act 56 (performed at device B), if device B is to be provided the given share access, a user of device B becomes aware of the device A share. This may occur, for example, by the user of device B navigating through some user interface mechanism (on device B) to determine which share access available DMAs are available for the current device. Device B may also be provided with a mechanism for configuring how media share notifications are provided to device B. For example, a user of device B may simply sense (for example, by viewing an ambient interface, by sensing vibration of device B, or by otherwise sensing the availability of the given DMA, for example, including an audio notification) that the given DMA is available (being shared by device A).

In a next act 58, also performed at device B, the user of device B requests increased or full access to the given DMA. Increased access may, for example, be in the form of a snack, and full access may, for example, be in the form of a meal.

FIG. 3 is a flow chart of a share fulfillment process. Share fulfillment involves providing the DMA to the target device, in this example, device B. In the illustrated embodiment, when share fulfillment occurs, device A, or some other entity in communication with devices A and B, manages the share fulfillment. Accordingly, at act 60, which may be performed at one, the other, or both of device A and some other entity, the DMA is provided to device B. In the example shown in FIG. 3, act 60 includes providing an additional sample (for example, a snack) or full access (for example, a meal).

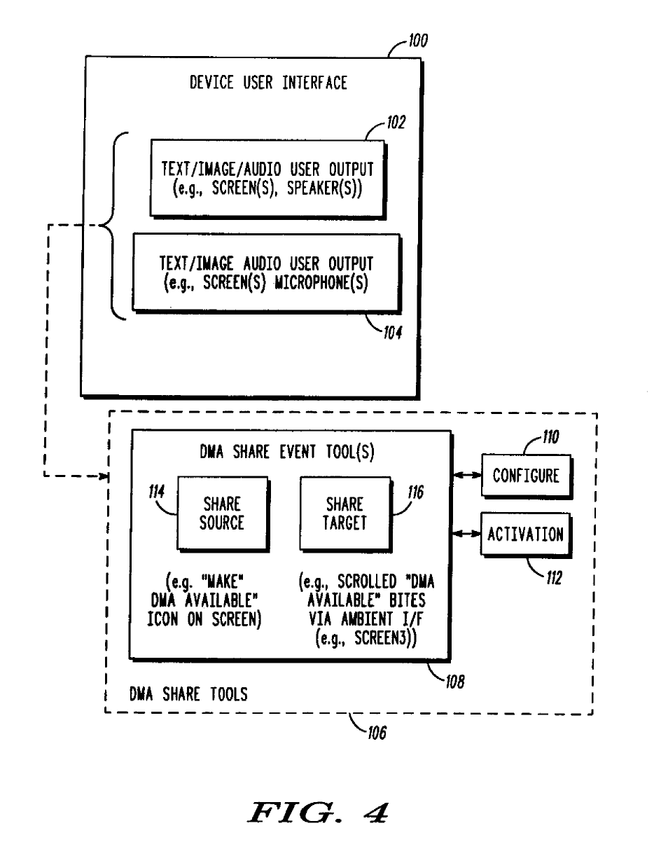

FIG. 4 is a schematic diagram of an example device user interface of the data transfer device 10 shown in FIG. 1. The illustrated device user interface 100 includes text/image/audio user output 102, and text/image/audio user input 104. User output 102 may include, for example, a display screen or display screens, and one or more audio speakers. In addition, the output may include a vibration mechanism or some other type of notification mechanism for communicating information to the user. The illustrated user input 104 may include, for example, keys, one or more display screens, one or more microphones, or any other user input device or mechanism.

The illustrated user output 102 and user input 104 are configured, in this embodiment, to implement one or more DMA share tools 106. The illustrated DMA share tools 106 include one or more DMA share event tools 108, a DMA share configure mechanism 110, and a DMA share activation mechanism 112.

The DMA share event tool or tools 108, in this embodiment, include a share source tool (or set of tools) 114 and a share target tool (or set of such tools) 116. The share source tool or tools 114 may, for example, make a given DMA available by allowing a user to interact with the current (source) device by pressing a given key intended to cause the given DMA to be made available to the target device, or it may involve providing a “make DMA available” icon on the screen, which can be clicked by the user of the current (source) device to cause the given DMA to made available to a target device.

The one or more share target tools 116 may include, for example, a scrolled “DMA available” notification displayed to the user (of the current, target, device) via an ambient interface. The ambient interface may include, for example, a SCREEN3™ interface.

The DMA share event tool or tools 108 may include graphical tools or other user interface tools. Graphical tools may include, for example, one or more menus, buttons, or icons. In addition, or in the alternative, the DMA share event tools 108 may include a hardware interface mechanism or mechanisms (for example, keys or buttons, a scroll wheel, or some other hardware interface mechanism).

A configure mechanism 110 may be provided which allows a user to configure the manner of operation, and interaction with the user, of one or both of the share source tool or tools 114 and share target tool or tools 116. An activation mechanism 112 may be provided to allow a user to activate one or more aspects of the share event tool functionality.

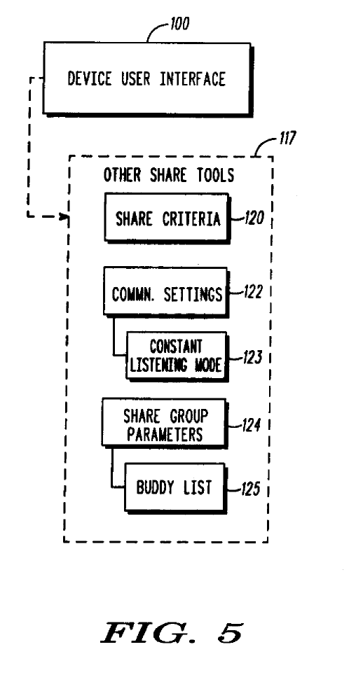

FIG. 5 is a schematic diagram showing portions of a device user interface 100, which portions include other share tools 117. The illustrated other share tools 117 include share criteria 120, communication settings 122, and share group parameters 124. The communication settings 122 may include tools allowing a user to configure the device so that it is in a constant listening mode via a constant listening mode communication settings mechanism 123. When the current device is in the constant listening mode, it will be constantly (e.g., continuously or intermittently) listening to determine if another source device is offering to share a given DMA with the current target device.

The share group parameters mechanism 124 may include a data structure field input 125 to allow a user to identify, configure, add to, or otherwise modify a “buddy list”, which designates those users or devices to which share opportunities from the current device, acting a source device, are to be provided, or from which share opportunities are to be provided to the current device acting as a target device.

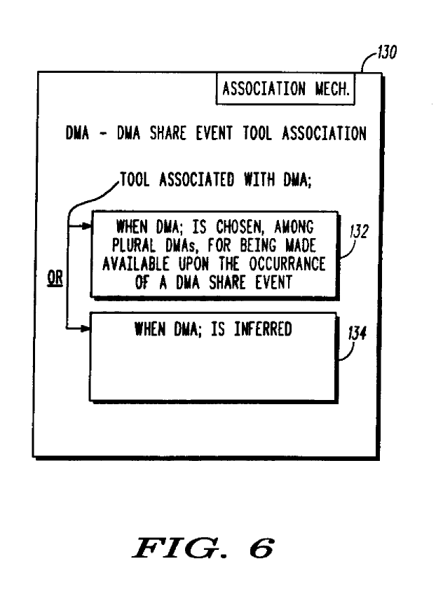

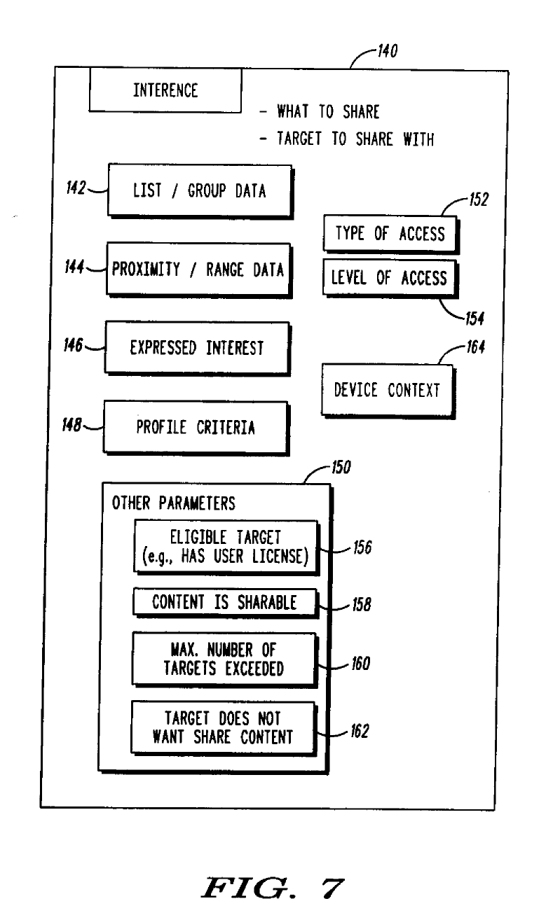

FIG. 6 is a schematic diagram of an example embodiment of an association mechanism 130, which may be an implementation of association mechanism 30 shown in FIG. 1. The illustrated association mechanism 130 causes an association between a given DMA and a share event tool. A share event may, e.g., be the user pressing a designed “share key” on the user's device. A share event may occur at a target device (e.g., when the user of the target device requests share access for a given DMA), and/or a share event may occur at a source device (e.g., when the user of the source device indicates that a given DMA is to be shared with one or more target devices). In these examples, each device associates the share event tool (e.g., the designated share key) with the given DMA to be shared, so the device's share process knows what DMA to share (if the device is a source device) or to request (if the device is a target device) when the share event tool is activated (i.e., in this example, when the designated share key is pressed).

A share event tool (for example, a share source tool or a share target tool, which may be a particular button, screen icon, or screen display component) is thus associated with the given DMA (DMAᵢ as illustrated in FIG. 6). This association may occur as shown in FIG. 6, at act 132, when the given DMA (DMAᵢ) is expressly chosen (e.g., by the user navigating through a sequence of device inputs), among plural DMAs, for being made available upon the occurrence of a DMA share event. Alternatively, the share event tool may be associated with the given DMA (DMAᵢ) by inference (e.g., when the given DMA is currently used by or presented to the user—depending upon the embodiment of the inference mechanism), as indicated at act 134.

The configure mechanism 110 shown in FIG. 4 may be configured to allow the DMA share event tool or tools 108 to be configured so that one or the other association approach as shown in FIG. 6 (i.e., act 132 or act 134) is utilized.

FIG. 7 is a block diagram of an inference mechanism 140, which is one embodiment of the inference mechanism 32 shown in FIG. 1. The illustrated inference mechanism 140 determines what DMA is to be shared, and the target device (or devices) to be provided share access to the DMA. The illustrated inference mechanism 140 includes list/group data 142, proximity/range data 144, expressed interest information 146, profile criteria 148, other parameters 150, data concerning the type of access 152 and the level of access 154, and device context data 164.

Each of the illustrated schematic “boxes” representing these types of data (142, 144, etc.) represent the data. In addition, or alternatively, they may be interpreted to represent console components, e.g., field or record inputs (e.g., via a user interface) and/or outputs (e.g., by display to a user of the data via a user interface).

The list/group data 142 may include data concerning a buddy list or a list of users or devices which should be considered or designated as target devices for a given share access. The proximity/range data 144 may include data for determining the target to which share access is to be provided based upon the proximity of the target device (to the current source device) and/or whether the target device is within communication range (with current source device). This proximity/range data may include, for example, information concerning whether the target device is within the same network (or within a common cell of the source device, for example, if the devices sharing the DMA are both mobile phones), or the proximity/range data may include, for example, other network information (for example, IP address ranges), that represents a proximity or relationship between the devices.

Expressed interest data 146 may include data concerning certain target devices and their expressed interest to receive share access to certain types of DMAs. This information can be obtained from a target device, for example, if the target directly communicates to the current device. This data can also be obtained, for example, by the current device interacting with some common registry entity, separate from the current device and the device that has expressed interest, but part of the same network.

Profile criteria 148 may include data indicating other types of profile criteria, helping a device determine the target device or devices to which share access should be provided for a given DMA or for a given set of DMAs.

Other parameters 150 may be provided, which in this embodiment include eligible target data 156, data concerning whether the content is sharable 158, a maximum number of targets exceeded 160, and data indicating that the target does not want share content 162. Eligible target data 156, for example, may include data concerning whether certain prospective target devices include user licenses for a particular DMA or type of DMA.

Device context data 164 may include data to help the device infer what to share. Such data may include, for example, information concerning the device's state (e.g., one device “state” is when it is running a given application; another “state” might be when the device is at a particular stage within a given application), and how the device's state may influence inferences as to what to share or the target(s) eligible for a share.

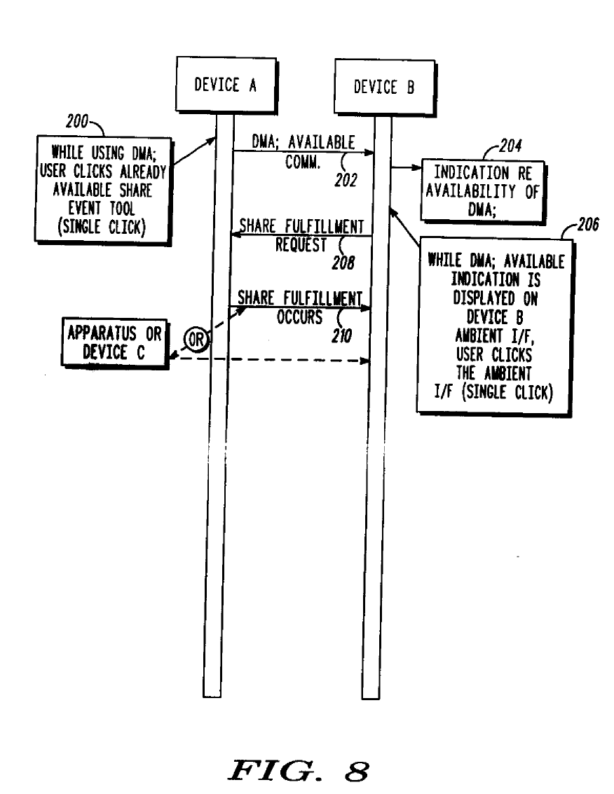

FIG. 8 illustrates the communication between devices A and B in one embodiment of a DMA share orchestration. In a first act 200, a user clicks device A (interacting, for example, with a particular icon or button designated for share indication on device A). While the user is using a particular DMA (DMAᵢ), for example, a particular multi-user game, the user clicks an already available share event tool. In one embodiment, a single click is all that is required by the user, while the user is currently using the given DMA (in this example, DMAᵢ). In a next act 202, device A performs a given “DMAᵢ available” communication 202. This involves a communication from device A to device B. Thereafter, at act 204, the user of device B is provided with an indication regarding the availability (for share) of DMAᵢ. Next, at act 206, during the given DMA (DMAᵢ) available indication, for example, displayed on a device B ambient interface, the user of device B interacts with the indication (in this case by clicking the ambient interface). In this embodiment, all the user of device B needs to do, to accept the share, is to perform a single click on that interface. At a next act 208, device B communicates the share fulfillment request to device A. At a next act 210, the share fulfillment occurs, in this example, by device A sending the fulfillment data from device A (or from apparatus C) to device B.

In one embodiment, the share fulfillment may include data causing device B to have complete access to a given session of a game currently being played by a user on device A. In another embodiment, the share fulfillment at act 210 may include data being sent from device A to device B causing device B to have access to a concurrent multi-party voice communication (for example, a telephone call) involving one or more users of one or more devices separate from device B, including device A (which is the source device providing access in this example).

In one embodiment herein, a user of a source device causes a single share event (e.g., by clicking a particular source share event tool), to cause the share access opportunity to occur for a designated target device or for one or more inferred target devices. This single share event may be performed at the source device, while the source device is performing another action, for example, running some other application unrelated to the shared given DMA. For example, inference mechanism 140 could be configured to infer sharing of a currently played song, which might be shared even while browsing the Internet with the source device.

The current activity of the device may not be affected by this share event. For example, the current activity of the device, including, for example, the device running a particular application, would not be paused, stopped, or put into background.

This could also be the case at the target device. For example, when a user performs a share event or events (for example, a single click in one embodiment) at the target device, the current activity at the target device is not affected, i.e., paused, stopped or put into background.

A given device may be configured so that it has an activate feature to activate the share receive function, by which shared DMAs are passively received without requiring any action by the user at the target device. For example, a given device user may wish to receive share opportunities of DMAs (for example, games, sessions for games, game licenses, or game executable code) without the user of that target device having to perform any action. This automatic/passive receipt of share access may include the opportunity to have access to a given DMA, with or without fulfillment.

A mechanism may be provided in a device to allow DMAs to be purchased, so that, as part of a fulfillment process, a purchase or license obtaining process may be provided.

The sharing of a given DMA from a source device to a target device may include bringing the target device into a current telephone call, or simply forwarding a current call from the source device to the target device. A DMA may include, for example, a link, for example, a URL.

The inference of whether a DMA is shared with a given target, may be performed at the target device, for example, by the target device determining the share source devices from which it will receive share access, for example, based upon configuration information, or the communications history of the target device. For example, the current target device may, through an inference mechanism, allow share access from those source devices which are in the target device's call, text message, or e-mail history.

Share events may be caused by hard or soft key activations. Changes to the length of a key press or to a key sequence could cause variations of share events. A process may be provided in a device, acting as a share source and/or as a share target, to allow the user to clarify how share orchestration or fulfillment is to occur for a particular share of a given DMA.

In operation, in certain illustrated embodiments, different digital media asset sharing scenarios may occur. For example, a user Mat may play a game. Meanwhile Jonathan can look over Mat's shoulder, and might be interested in the game. Mat, in one click, may broadcast information about the game. The broadcast can occur in a couple of ways, which may involve Jonathan receiving the information. Per an active delivery approach, Jonathan indicates his interest in receiving the shared information by performing a corresponding “receive interest” click at his phone.

Jonathan may click before Mat clicks, depending upon the implementation. For example, the devices can be configured in a pull configuration, whereby the target device user indicates an interest in receiving share access to the game, by clicking first. The source device user, in this case Mat, then clicks to allow the share access in response to the interest. The allowing of share access may include fulfillment or simple share orchestration and access.

If the embodiment is a push embodiment, then the source device user, Mat, needs to click first, and the target device user, Jonathan, clicks to confirm his interest which results in fulfillment of the share access to the game. In a passive delivery approach, Jonathan may configure his device, or the device may be already configured that way, so that Jonathan does not have to perform any action to receive the shared information. Jonathan would, therefore, perform zero clicks in order to obtain the shared DMA. Jonathan could interact, for example, with a SCREEN3™ on his device, to purchase a game to which he does not currently have a license, via an operator portal, and to subsequently download the game either from the source device (Mat's phone in this example) directly, or from a server residing in the network.

If Jonathan already owns the game, and it is already on his handset, the shared DMA may be an invitation to play the game against Mat. In this example, Jonathan would then interact with the SCREEN3™ item to launch the game in multi-player mode against Mat.

In another embodiment, the share may occur when each of Jonathan and Mat clicks (e.g., Jonathan clicking to indicate a desire to receive the share and Mat clicking to indicate a desire to offer the share), provided they click within a predetermined amount of time of each other. As a variation to this embodiment, it may not matter whether Mat or Jonathan clicked first. Concurrent “clicking” by Jonathan and Mat (i.e., if one clicks while the other is still depressing his device's share button) might be the share event triggering activity.

Device-to-device communication may be performed, for example, using GPRS, a physical connection (for example, near field communication, physical mating USB-2-Go, memory stick), or a proximate connection (e.g., Bluetooth, or Ad-hoc Wi-Fi).

The way sharing is inferred, may depend upon the current application being run on the source device (and/or the target device). For example, a given game application may include functionality whereby a user can specify the type of share that may occur concerning that game. For example, a game application may allow invitations for a multi-player game session to be sent to one or more target devices, upon the user at the source device clicking a one-click share button when viewing a multi-player lobby screen within that game. The manner in which sharing occurs between devices may be controlled, for example, by including data or settings in applications loaded onto the device. Applications can be originally written and compiled to include such data or settings controlling DMA shares, and/or applications can be updated to include such data or settings, by the device interacting with an online update service.

In addition, or in the alternative, the operating system of the device itself, separate from the application, may include DMA share functionality, configurations, and settings. For example, the settings of an application on a device could be overwritten by operating level DMA share functionality.

In accordance with one embodiment of the disclosure, a short click at the source device might cause a share of an inferred DMA, while a long click might offer the user of the source device a different action. For example, the user might be asked to utter a command or otherwise input a command indicating a particular target device, or a particular DMA to be shared. Other user interactions with the source device could also cause this functionality. Similar features could also be provided at the target device, to allow or disallow certain types of share access opportunities to that device.

A user at a source device may be provided with feedback indicating that the share did not succeed, or otherwise requiring more information to continue with providing share access. The user at the source device could be allowed to stop the share activity. The user at the source device could explicitly resolve any issues, for example, if the share orchestration process could not infer or otherwise effect the share access for a given DMA.

A given device may be configured to allow it to receive a fulfillment of a given shared DMA only in certain circumstances, for example, when the device is at its idle screen. When the device is not in the idle screen, but using a particular application, the user may allow the device to receive a share fulfillment by performing a special action, e.g., a simple one click action. For example, the user may hold the single click share allow button for a longer period of time.

Information sharing between the devices may be facilitated using any type of protocol, for example, SMS, MMS, OBEX over Bluetooth, e-mail over Wi-Fi, or any new or other protocol. Information may be encrypted.

Sharing may be facilitated between two or more devices by providing a short term memory facility (e.g., one or more features of the “Appbus” may be employed, as described in Janssen et al., “Appbus: providing short term memory for mobile devices,” Consumer Communications and Networking Conference, 2006 CCNC 2006, 2006 3^{rd} IEEE Vol. 2, Issue 8-10, pp. 1078-1082 (January 2006)), resident on each participating device. This memory facility may include a transient data store and event notification framework that together allow loosely coupled applications to collaborate. Applications may collaborate with other applications, for example, on a different device, via a non-local short term memory facility instance.

Share orchestration may be distinct from share fulfillment. Share orchestration deals primarily with the signaling of an intent to share from or via the source device, and/or the registration of interest in shared access from or via the destination device. Share fulfillment involves getting the asset of interest in one way or another to the destination device.

Both the sharing and receiving (source and target) devices may be provided with temporary agents to carry out share orchestration. Share agents may also be provided in each device to interface the temporary agents with device applications that are participants in the share framework. Applications may participate in two different ways: (1) an application can share an asset, or (2) an application can be notified of an opportunity to receive a share. A separate agent called a share bridge agent may be provided which is concerned with the propagation of locally originated share references to nearby devices, as well as receiving incoming share references that have originated on nearby devices. The share bridge agent may operate in two different modes. As a server, the share bridge agent may serve locally originating share references to nearby devices. As a client, the share bridge agent may actively discover share references served by nearby devices. Accordingly, the share bridge agent may operate as a server and a client simultaneously. The interaction of two share bridge agents may involve the exchange of share references in both directions, hence providing an opportunity for collocated devices to implement a viral sharing scheme.

From an end user perspective, the orchestration of a share may occur (or be enabled or controlled) in response to implicit or explicit intervention, or in response to a combination of implicit and explicit intervention. For example, in one implementation, the device operating environment may automatically place a share reference germane to the currently running application on the transient memory facility. For example, a photo viewing application might routinely put the file URL of the photo currently being viewed on the transient memory facility. This entry on the transient memory facility, and the fact that photo viewing application currently has focus (which could also be represented as an entry on the transient memory facility) could be sufficient for the underlying share framework to deposit a representative share reference on the transient memory facility. In another implementation, the share reference to the photo currently being viewed may not be placed on the facility unless the user expresses an intent to share it via explicit intervention (for example, clicking a share button or option from a menu).

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees, and others.

1. Apparatus comprising:
media and a data structure encoded on the media to hold one or more digital media assets (DMAs); and
one or more share tools configured to provide at least one target device of plural separate communication devices with share access to a given DMA to which another source device of the plural separate communication devices has access, the one or more share tools being configured so that the share access is provided in response to a single share event at a given one of the source and target devices.

2. The apparatus according to claim 1, further comprising:
a display; and
a user interface associated with the display.

3. The apparatus according to claim 1, wherein the one or more share tools is further configured to cause the share access to the given DMA when the single share event occurs within a predetermined time period of a share event at one of the source and target devices other than the given one.

4. The apparatus according to claim 1, wherein the one or more share tools is further configured to cause the share access to the given DMA when the single share event occurs concurrent with a share event at one of the source and target devices other than the given one.

5. The apparatus according to claim 1, wherein the one or more DMAs include data causing the apparatus to have access to a concurrent media experience involving one or more users of one or more devices separate from the apparatus.

6. The apparatus according to claim 1, wherein the single share event includes one click at the source device of the plural separate communication devices, to thereby provide the share access to the target device.

7. The apparatus according to claim 1, wherein the single share event includes one click at a target device of the plural separate communication devices, the target device not yet having access to the given DMA, to thereby provide the share access to the target device.

8. A method comprising:
encoding, on media, a data structure to hold one or more digital media assets (DMAs); and
providing at least one target device of plural separate communication devices with share access to a given DMA to which another source device of the plural separate communication devices has access, the share access being provided in response to a single share event at one of the source and target devices.

9. The method according to claim 8, further comprising causing the share access to the given DMA when the single share event occurs within a predetermined time period of a share event at one of the source and target devices other than the given one.

10. The method according to claim 8, further comprising causing the share access to the given DMA when the single share event occurs concurrent with a share event at one of the source and target devices other than the given one.

11. The method according to claim 8, wherein the one or more DMAs include a media file.

12. The method according to claim 8, wherein the one or more DMAs include data causing the target device to have access to a media experience involving one or more users of one or more devices separate from the target device.

13. The method according to claim 8, wherein the single share event includes one click at the source device, to thereby provide the share access to the target device.

14. The method according to claim 8, wherein the single share event includes one click at the target device, to thereby provide the share access to the target device, the method further comprising additional single share events at one or more respective other target devices of the plural separate communication devices, to thereby provide the share access to each of the one or more other target devices.

15. An electronic device comprising:
media and a data structure encoded on the media to hold one or more digital media assets (DMAs); and
one or more share tools configured to provide at least one of plural separate communication devices with share access to a given DMA to which another of the plural separate communication devices has access, the share access being provided in response to a single share event at one of the plural separate communication devices.

16. The electronic device according to claim 15, wherein the one or more share tools is further configured to cause the share access to the given DMA when the single share event occurs within a predetermined time period of a share event at one of the source and target devices other than the given one.

17. The electronic device according to claim 15, wherein the one or more share tools is further configured to cause the share access to the given DMA when the single share event occurs concurrent with a share event at one of the source and target devices other than the given one.

18. The electronic device according to claim 15, wherein the one or more DMAs include a media file.

19. The electronic device according to claim 15, wherein the single share event includes one click at the source device, to thereby provide the share access to the target device.

20. The electronic device according to claim 15, wherein the single share event includes one click at the target device, to thereby provide the share access to the target device.
